(19) United States
(12) Patent Application Publication
(10) Pub. No.: US 2017/0020343 A1
(43) Pub. Date: Jan. 26, 2017

(54) HOLDER DEVICE FOR SLICING FOOD ITEMS

(71) Applicant: John Skoko, Montebello, CA (US)

(72) Inventor: John Skoko, Montebello, CA (US)

(21) Appl. No.: 14/804,843

(22) Filed: Jul. 21, 2015

(51) Int. Cl. A47J 43/28

(52) U.S. Cl. CPC A47J 43/283

(57) ABSTRACT

A device for safely holding a food item, the device comprising two contoured, identical plates bound together at one edge by a spiral wire coil, such that the plates define a space in between configured to receive and safely hold the food item for slicing. The device further comprises a plurality of protrusions on an inner face of each plate, adapted to grip the food item placed in between the two contoured, identical plates.

### FIELD OF THE INVENTION

The present invention generally relates to safety devices for slicing food items and more specifically relates to a holder device for safely holding food items including bagel, English muffin, French roll and other similar foods, while slicing these food items.

### BACKGROUND

Bagels, rolls, and buns that are baked from a bread or other dough may come in many shapes and sizes. Cutting or slicing food items such as breads, buns, rolls, and bagels into symmetrical halves or various sizes or pieces requires one to hold the food item in one hand and slice the food item using a knife in the other hand. However, an individual using a knife to cut or slice an article of food faces a significant safety risk that they may accidentally injure or cut themselves. For example, holding a bagel in one hand while safely, accurately and quickly cutting the bagel with a knife held in the other hand is more difficult than other types of food because of the bagel's hard outer crust, dense inner mass and relative narrow width. The cutting is usually done along the cross-sectional dimension of the bagel to expose a greater surface area of the inner portions of the bagel.

There exists two most common types of devices for holding food items such as bagels, a first type of device is rigid in construction and requires to be placed on a leveled surface, like a counter top surface. The food item is placed inside a compartment comprising two halves with a slot in between for receiving a knife blade configured to transversely cut through the food item. The second type of food holding device comprises two plates hinged or attached together for holding a food item in one hand and sliced using a knife held by the other hand.

For instance, some known bagel, roll, and bun holding devices are difficult to clean and are too bulky to be easily placed inside a kitchen storage unit. Further, conventional bagel holding devices are not capable of holding other food items such as flat muffin or French rolls or similar food items. In addition, traditional food holding devices comprising U shaped structure requires the knife blade to hit the bottom of the device, which may result in damaging the knife blade. Many of the existing food holding devices are bulky and not suitable for safely holding the food item in one hand.

Therefore, there exists a need in the art for a food item holding device for slicing, without damaging the knife blade or injuring the user, wherein the device can be easily cleaned and stored in kitchen storage unit.

### SUMMARY OF THE INVENTION

The present invention relates to a device for safely holding a food item for slicing, the device comprising two contoured, identical plates bound together at one edge by a spiral coil, such that the plates define a space in between configured to receive and safely hold the food item for slicing. The device further comprises a plurality of protrusions on an inner face of each plate, adapted to grip the food item placed in between the two contoured, identical plates.

In an embodiment, the two contoured, identical plates are semi-circular in shape. The plates and the spiral coil are made of stainless steel or similar rigid material. The food item may comprise bagels, French rolls, English muffins, breads, buns, croissant and the like. The food holding device of the present invention allows safe handling of food items for slicing or cutting using a knife, without injuring the hands of the user. The contoured, identical plates with protrusions on the inner face, offers a firm grip for holding the food item during slicing or cutting.

In an embodiment, the semi-circular plates of the device, comprises a plurality of holes along the diametrical edge. The holes are configured to receive the spiral coil which holds together the diametrical edge of the plates thereby defining a space in between to receive the food item. The plates comprises a contoured surface to hold the food item such as bagel, roll, muffin etc. The contoured plates and the spiral coil design facilitates easy cleaning of the device and compact device design allows storage of the device along with other kitchen utensils.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF SEVERAL VIEWS OF DRAWINGS

FIG. 1 is a front perspective view of the food holding device.

FIG. 2 is a side perspective view of the food holding device.

FIG. 3 is an end view of the food holding device.

### DETAILED DESCRIPTION OF PREFERRED EMBODIMENTS

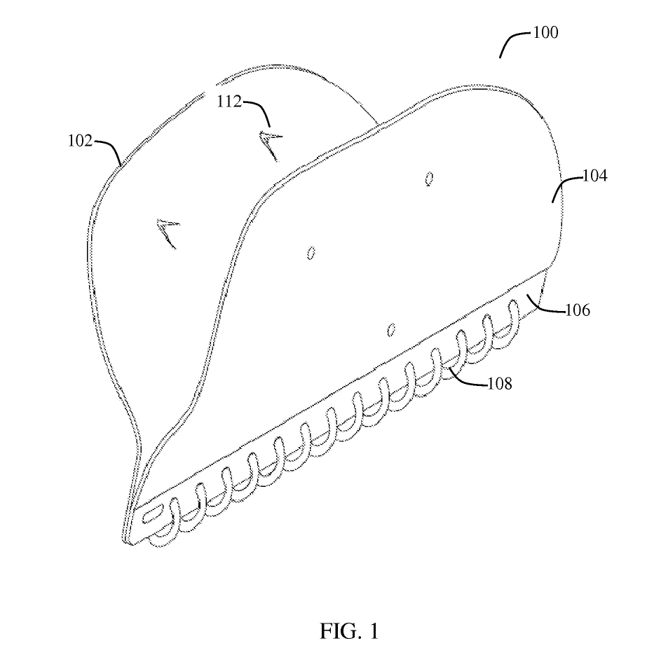

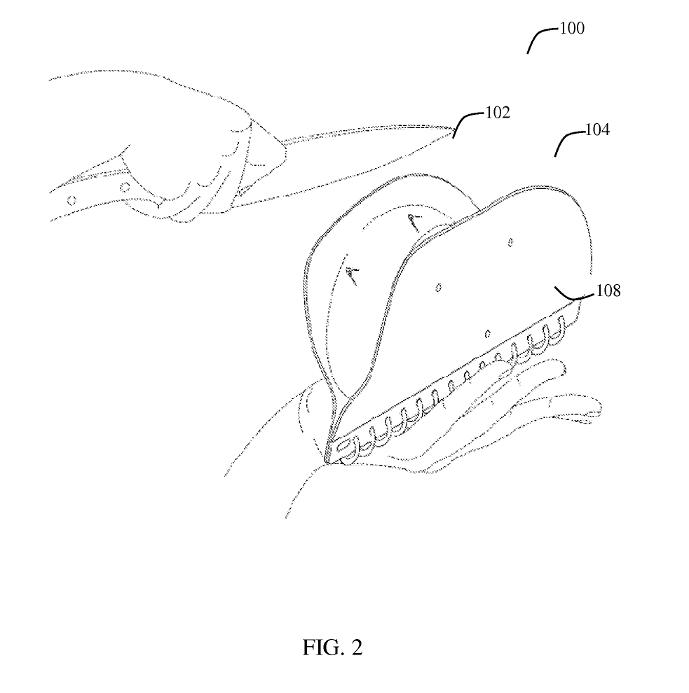

Referring to FIG. 1 and FIG. 2, illustrates a front perspective and side perspective view of the device 100 for safely holding food items while slicing or cutting. The device 100 comprises two contoured, identical plates 102, 104 bound together at one edge 106 by a spiral coil 108. The diametrical edge 106 of the plates 102, 104 comprises a plurality of openings to receive the spiral coil 108, such that the plates 102, 104 define a space in between configured to receive and safely hold the food item for slicing.

The device 100 further comprises a plurality of protrusions 112 on an inner face of each plate, adapted to grip the food item placed in between the two contoured, identical plates 102 and 104. The plates 102, 104 can be moved apart by starting along the circumferential edges towards the center, to place the food item in between the plates prior to slicing using the knife.

The device 100 is configured to safely hold food items for slicing, the food items include but not limited to bagels, buns, bread, French rolls, English muffins, croissant, and the like. Typically, the food items are held by the device 100 using one hand and sliced using a knife held in other hand. The device 100 is portable and allows to be easily cleaned by dusting, wiping or washing using detergents or by placing in a dishwasher. The device 100 can be easily stored along with other kitchen utensils in a kitchen storage unit or similar storage structures.

The food holding device 100 of the present invention allows safe handling of food items for slicing or cutting using a knife, without injuring the hands of the user. For example, a bagel can be placed in between the two contoured, identical plates 102 and 104, the bagel is held in place by the protrusions 112 present on the inner face of the plates 102, 104. The bagel is sliced using the knife or similar cutting tool without injuring the hands. The space defined between the two plates can be adjusted according to the food item to be sliced. The device is configured in such a way that the knife blade completes the cut without touching the bottom of the device, thus preventing damage to the blade.

In an embodiment, the contoured, identical plates 102, 104 and the spiral coil 108 are made of food grade stainless steel material, which is safe, hygienic, allows easy washing and prevents the plates from rusting. The device 100 is safe, durable and long lasting. Further, the open bottom formed by the spiral coil allows food crumbs or similar food remains to fall through the coil.

In an alternate embodiment, the diametrical edge of the two plates 102 and 104 can be removably attached by a hinge member. In an embodiment, the hinge member may comprise a spring element allowing adjustment of the space between the inner face of the two plates 102 and 104.

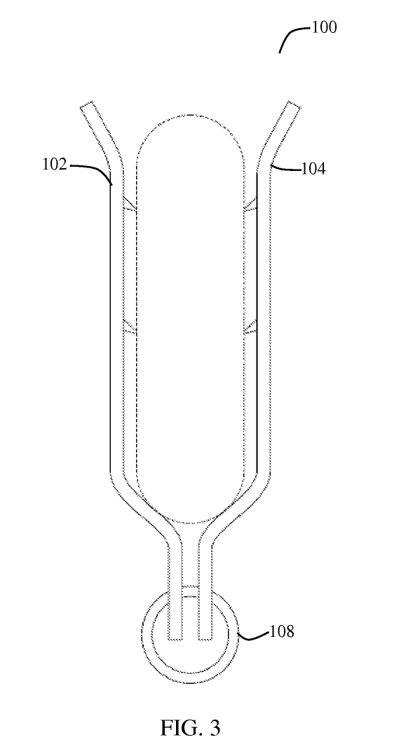

FIG. 3 illustrates an end view of the food holding device, according to an embodiment of the present invention. The two identical plates 102 and 104 are held together at the diametrical edge by the spiral coil 108, thereby defining a space in between to hold a food material such as a bagel. The plates 102 and 104 comprises contour shaped to receive and hold the bagel.

As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A device for safely holding a food item, the device comprising:
two contoured, identical plates bound together at one edge by a spiral wire coil, such that the plates define a space in between configured to receive and safely hold the food item for slicing.

2. The device of claim 1, further comprises a plurality of protrusions on an inner face of each plate, adapted to grip the food item.

3. The device of claim 1, wherein the plates are semi-circular in shape.

4. The device of claim 1, wherein the plates and the spiral coil are made of stainless steel.

5. The device of claim 1, wherein the food item is selected from a group comprising bagel, French roll, croissant, bun and English muffin.
